(19) United States
(12) Patent Application Publication
(10) Pub. No.: US 2012/0259794 A1
(43) Pub. Date: Oct. 11, 2012

(54) Method and Apparatus for Visualizing and Analyzing Unit Pricing for Digital Product Purchases to Determine Revenue Optimization Opportunities for Service Provider

(76) Inventors: Matthew R. SHANAHAN, Seattle, WA (US); Jennifer L. Hinds, Woodinville, WA (US); Mechthild R. Kellas-Dicks, Coquitlam (CA)

(21) Appl. No.: 13/083,492

(22) Filed: Apr. 8, 2011

(51) Int. Cl. G06Q 10/00; G06F 17/30

(52) U.S. Cl. 705/348; 705/1.1; 707/737; 707/E17.001

(57) ABSTRACT

Customers who purchase a digital service under a subscription-like payment model are grouped according the value each receives, which is computed from stored transaction data as the amount the customer pays divided by the benefit the customer receives. Customers who pay more or less than a mid-range “normal” price may be given price adjustments to bring the value they receive closer to the normal price.

### FIELD

The invention relates to analyzing pricing information about services. In particular, the invention relates to visualization and analysis techniques for identifying pricing anomalies and optimizing revenue opportunities.

### BACKGROUND

In basic economic theory, and often in the real world, markets for goods and services can be understood in terms of a three-way, self-stabilizing equilibrium between price, supply and demand. When demand for an item outpaces supply, the price generally rises; whereas when supply exceeds demand, the price falls. Or, from another viewpoint, a price increase clue to increased demand or inadequate supply may encourage production (and thus increased supply), leading to a price correction. Changing prices may also affect demand (in generally inverse proportion), leading to corresponding changes in supply that bring the price back to a theoretical equilibrium point near the cost to provide the demanded quantity of product as efficiently as possible. This framework provides a powerful tool for analyzing markets, and easily accommodates many different economic forces affecting the production and consumption of goods and services.

One situation that is often difficult to analyze arises when the cost to provide a service is not strongly correlated with the amount of service provided (in other words, when the marginal cost is near zero). Then, rather than the price approaching an equilibrium near the cost to efficiently supply the item, the price may be related to the cost to enter the market, the price of substitute items, or simply the price at which sales meet the supplier's desired target.

A simple model for setting pricing in this situation might assume that demand (D) is linearly correlated with price (P):

D=eP+d₀

(See FIG. 2A.) That is, if the price is zero, demand will be at d₀; thereafter, increasing price will reduce demand until the price reaches the point at which no-one wants the product, dₚ. The slope of the line, e, indicates the elasticity of demand, or how quickly interest in the product wanes as the price increases.

The business wishes to set a price that maximizes its profit (F). Since the marginal cost is zero, profit is simply price×demand at that price:

$$\begin{matrix}F = P \cdot D ( P ) \\ = {eP}^{2} + {d}_{0} P\end{matrix}$$

(See FIG. 2B.) A maximum of F occurs where F′=0:

F′=2eP+d₀

Thus, the business should set its price to:

$${P}_{{F}_{max}} = \frac{- {d}_{0}}{2 e}$$

(Note that e is negative, so the profit-maximizing price is positive. Furthermore, as can be seen by inspection of the graphs in FIGS. 2A and 2B,

$${P}_{{F}_{max}} = \frac{{d}_{p}}{2} . )$$

Unfortunately, determining d₀ and dₚ is not trivial, and even if it was, the overall model empirically lacks predictive power. For a business selling near-zero marginal-cost services, an improved analytical framework for optimizing pricing may be extremely valuable.

### SUMMARY

Embodiments of the invention extract and highlight important information from a database of service sales information, predict optimal pricing versus demand curves, and present the information graphically so that human managers can easily perceive misalignments in pricing effects or evaluate the efficacy of price model changes. The information can also be processed automatically as part of a feedback loop to optimize revenue opportunities without manual intervention.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows an environment where an embodiment of the invention may be applied.

FIGS. 2A and 2B show sample relationships between price, demand and profit for a zero-marginal-cost service.

FIG. 3 shows a sample demand map prepared according to an embodiment.

FIG. 4 shows how the sample demand map of FIG. 3 may change after implementation of a revenue-optimization tactic.

FIG. 5 is a flow chart outlining the creation of a demand map.

FIG. 6 shows a schematic representation of inputs, controls and outputs of a demand-map system embodiment.

### DETAILED DESCRIPTION

Embodiments of the invention operate on information collected during the sale of digital services (i.e., services that can be delivered electronically) and help the seller optimize its price-setting to improve overall profitability. Through the use of intuitive parameters and easily-interpreted graphical displays, opportunities are easy to identify and evaluate, and service managers can better understand the composition of their customer base. Correlations between customer sub-groups (e.g., geographic groups, industry groups, firm affiliations) and pricing/revenue performance become clearly evident, and historical trends (including the effects and effectiveness of business campaigns and initiatives) are easy to spot.

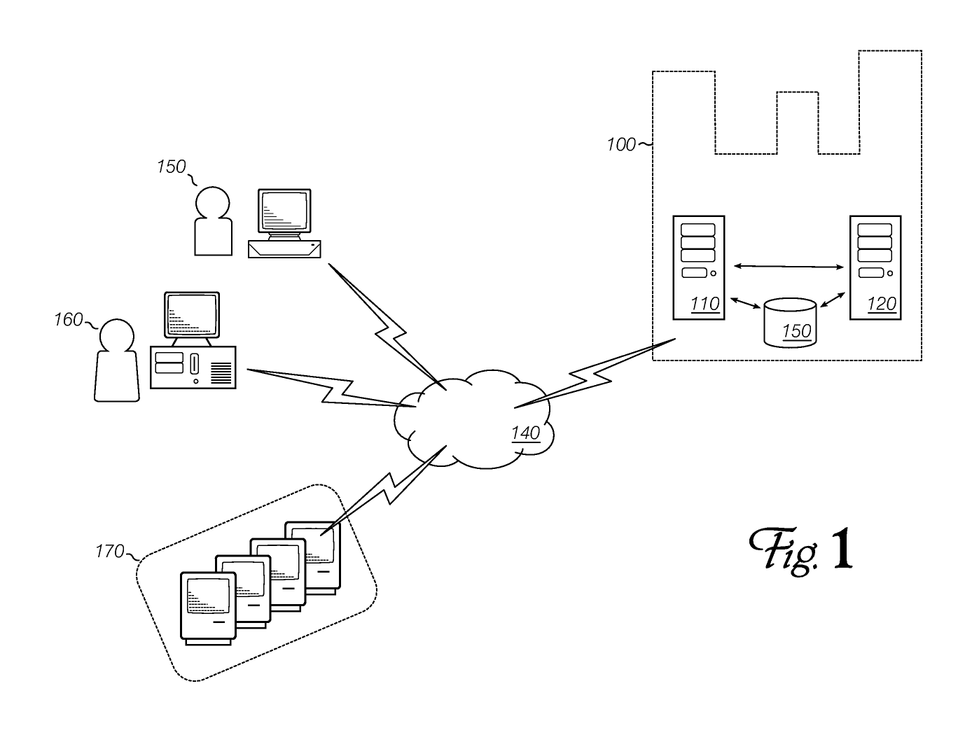

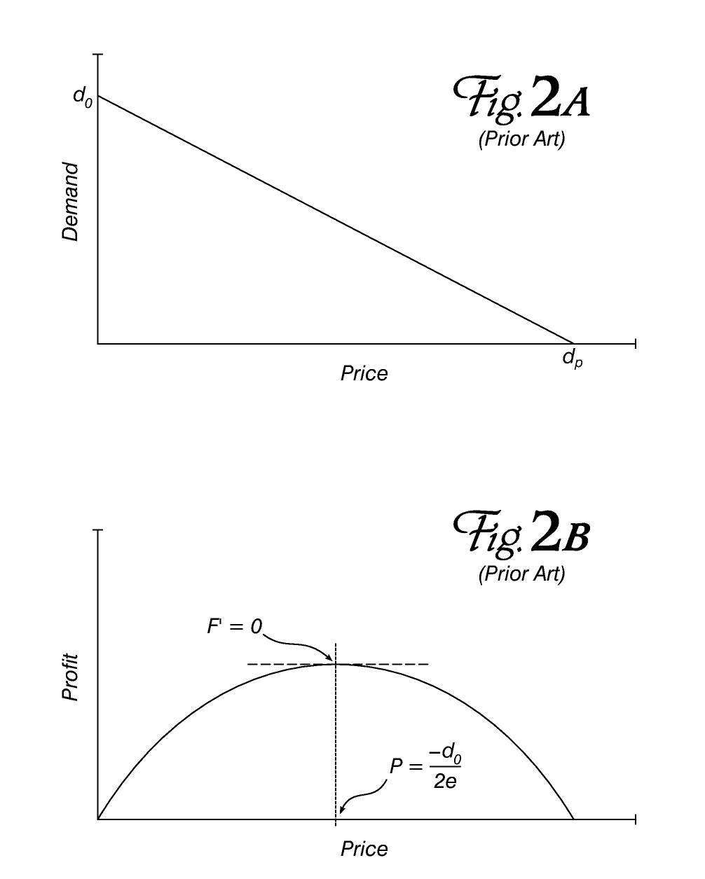

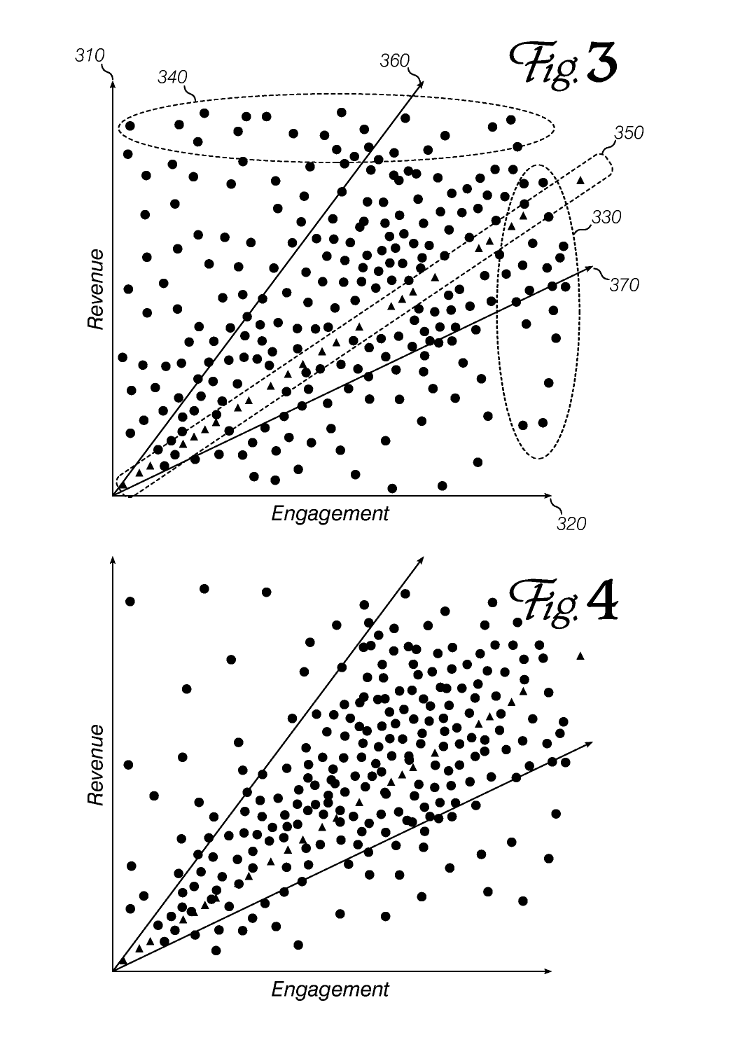

FIG. 1 shows a sample environment where an embodiment of the invention may be used. A business 100 operates a number of computers 110, 120 to support and monitor the provision of a digital service to customers 150, 160, 170. For example, business 100 may be an electronic publisher or service provider, and its digital services may include news stories, digital images, audio recordings, real-estate information, data processing services, or other things. As discussed above, the digital services may be zero-marginal-cost items, but this is not essential. Embodiments of the invention can help optimize price-setting for non-zero-marginal-cost services, as well as services that are not even “digital” (in the sense that they cannot be delivered electronically).

Customers request and receive the service over a distributed data communication network such as the Internet 140. Customers may be individuals (150, 160) who use the service themselves, or other businesses 170, which purchase the services for the use of their employees in serving their customers.

Business 100 may sell the service under any sort of revenue model. For example, some customers may pay a per-item fee to receive the service, while others may purchase by duration of authorized access or quantity of data downloaded. Business customers often purchase an “all you can eat” subscription, which allows their employees to use the service whenever necessary in their work.

Business 100 collects information about how customers interact with its services and stores the information in a database 150. Embodiments of the invention, often implemented as computer programs to assist an employee of the business in managing the marketing and sales of the service, refer to the information in database 150.

Embodiments of the invention operate by extracting and relating two metrics about the business's operation from the stored data. The first metric is Revenue, which is proportional to some parameter that the business wishes to optimize. (Often—but not necessarily—the parameter to be optimized is profit, which is closely coupled with price.) The second metric is Engagement, a measure of identifiable customer behaviors such as page views, document downloads or access session durations.

If a business exclusively uses what we will call a “pay-per-view” model, then every customer will pay the same price for each “unit” of engagement. The delivery of individual television programs is an eponymous example of this model; another example is an online music download business with a fixed price per song. Here, each customer pays the same amount for the same number of engagements, and optimizing the price may simply be finding the midpoint between zero and the price at which no-one buys the product because it is too expensive.

However, many businesses wish to offer alternative payment plans, either in response to customer demands or in consequence of the fact that the pay-per-view model imposes accounting costs on the business and does not establish a reliable recurring revenue stream. These alternate plans can be viewed as subscriptions of varying length, and possibly including a cap on engagement.

Under a subscription plan, the price a user pays per engagement may vary widely. Subscribers at the same monthly price may make different use of the product or service, and even a single subscriber's use may vary from month to month, causing his per-engagement cost to fluctuate. This variation means that some users may be paying more or less than others, even if they receive the exact same benefit. From the provider's perspective, it means that the price offered to some users is too low, while the price offered to others may be too high. Embodiments of the invention help identify the mis-priced users, quantify the discrepancies, and set the price just right.

The general principles of an embodiment can be understood with reference to the sample demand map shown in FIG. 3. An embodiment need not actually produce or display such a map, as long as it can identify the groups of users and pricing discrepancies discussed below.

A demand map is a two-dimensional scatter plot presenting information from an online-sales-activity database. A first axis 310 shows increasing revenue, while a second axis 320 shows increasing engagement. Each point represents a user's activity over a period of time covered by the demand map. Users at the right side of the graph (330) are highly engaged—they use a lot of the service. (E.g., they may read many articles, download many songs, or spend many hours searching legal databases) Users at the top of the graph (340) pay a lot for their use. Pay-per-view users whose activity was plotted on the graph would appear along a straight line from the origin (350), but users under alternate pricing plans appear scattered across the graph.

The area of the demand map (a quarter plane representing revenue values greater than or equal to zero, and engagement values greater than or equal to zero) is divided into three regions by rays 360 and 370. Each region contains, roughly speaking, users who receive similar value from their use of the services (on a revenue-per-engagement scale).

Users who fall in the triangular area between axis 310 and ray 360 pay more than average for their use of the service, and consequently there is a risk that they will decide to discontinue their subscriptions or find a substitute service. On the other hand, users in the triangular area between ray 370 and axis 320 pay less than average for their use. There is a chance that these users (particularly the highly-engaged users toward the right of the map) would be willing to pay more for the service. The demand map exposes useful information about a population of customers, identifying two groups that may be worth further study. For the overpaying group, the business may offer less-expensive subscriptions or undertake efforts to increase those customers' engagement. For the underpaying group, subscription plans tailored to be attractive to high-engagement customers, or simple price increases, may be implemented.

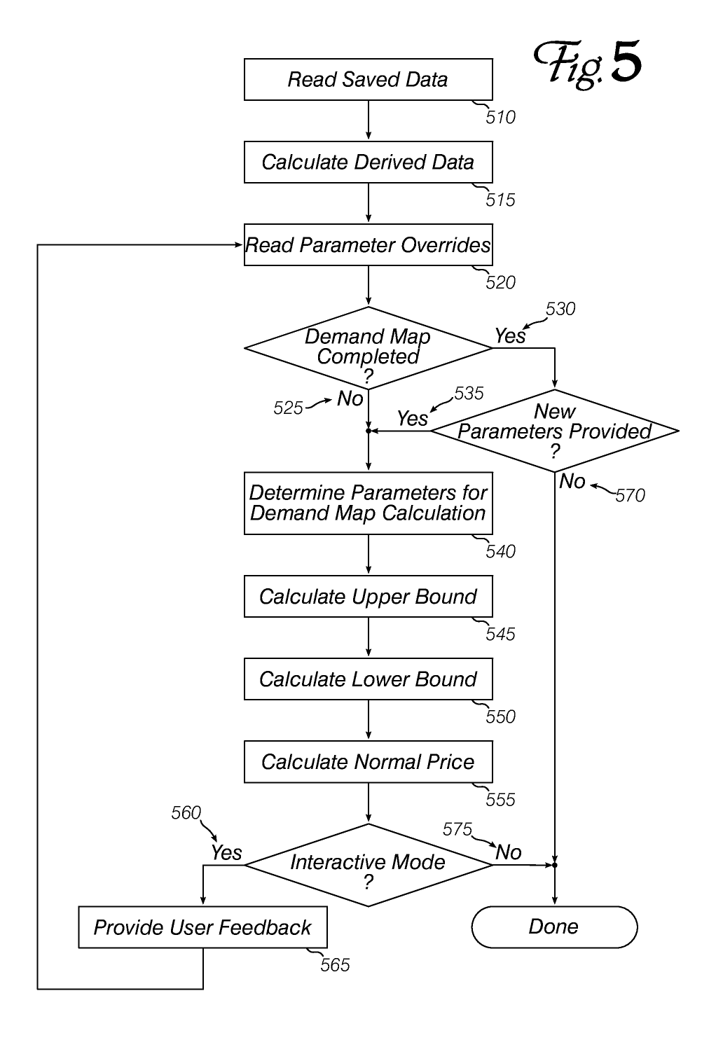

After successful implementation of plans targeting customers in the identified groups, a new demand map may show that there are fewer overpaying or underpaying customers (FIG. 4). In addition, the average revenue per user is likely to increase.

A demand map can also suggest what an appropriate pay-per-view price is. As the business adjusts its prices and policies to eliminate overpayment and underpayment, customers plotted on the map will fall closer and closer to a diagonal line through the origin. The slope of the line is the equivalent per-engagement price of the business's pricing models (disregarding any administrative costs of instituting a per-incident price). Thus, this line can be considered a “normal unit price” line. For customers who fall below the minimum price line (e.g., line 370 in FIG. 3) in a particular Demand Map, normal unit price can serve as a target for adjusting the customer's pricing. Furthermore, the difference between the customer's actual price and the minimum price line is an estimate of the minimum value of the opportunity available by correcting the user's pricing; a “better-case” estimate can be made by reference to the difference between the user's price and the normal price line. Or, in the aggregate, the differences can be summed to make pessimistic and optimistic estimates of the value of expending time and effort on correcting pricing overall.

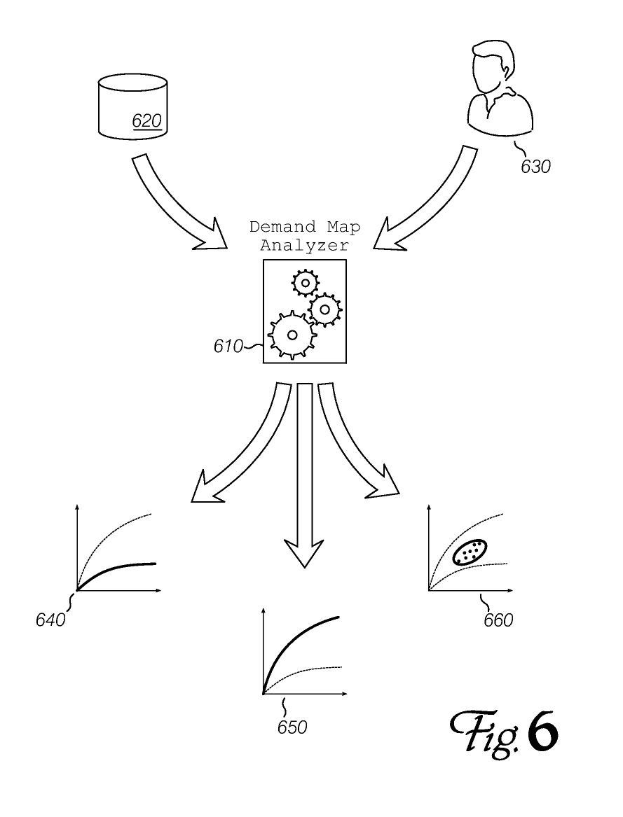

FIG. 5 is a flow chart outlining the preparation of a demand map according to an embodiment of the invention. First, data about customer payments and use of the service is read from stored databases (510). Next, derived measures “Revenue” and “Engagement” are computed (515). For example, the monthly subscription fee paid by a corporate customer may be divided by the number of authorized users (employees of the corporation), and engagement may be measured by the number of different clays during the month that each authorized user logged in, the amount of time each user spent interacting with the service, or the volume of data retrieved.

Now, parameter overrides are obtained (520) to change default (or previously-specified) demand map parameters. If the demand map has not yet been completed (525), or it has been completed (530) but new parameters have been provided (535), then derived parameters (e.g., range & scale) are determined (540). Upper (545), lower (550) and normal prices (555) are calculated, and if the embodiment is operating in an interactive mode (560), then the resultant map may be displayed (565) and the user is given the opportunity to adjust the parameters (520) to fine-tune the map. In a non-interactive mode (575), or if the demand map is completed (530) and no new parameters were provided (570), the prepared map resulting from operations 540-555 is returned for subsequent processing.

Next, we describe in greater detail a practical embodiment of the invention. The general principles are as previously discussed, but changes and optimizations are made in several particulars. For example, this embodiment allows for volume discounts by changing the linear “rays” (FIG. 3, 360 and 370) to curves that increase less than linearly for increasing engagement. This model can also serve for analyzing pricing of “indirect services,” where the customer is purchasing something for a third party. One example of this is online advertising: businesses may pay a fee to have their advertisement displayed to clients or visitors of the seller's website. A demand map can help identify advertisers that pay too little or too much for this advertising.

FIG. 6 is a representation of the inputs, controls and outputs of this embodiment. The central object 610 is a computer program (or suite of cooperating programs) that takes business information 620 collected from customers, and control parameters, optimization targets and other guideline information from a user 630, and produces demand maps and related information such as maximum and minimum price lines 640, 650, and identification of groups of customers 660.

In this embodiment, business information 620 comprises purchased units such as individual user licenses. Each purchased unit has a unique identifier such as an account name (or, for an advertising-price-optimization implementation, an advertisement order number). Each purchased unit also has a monetary value attached (e.g., a license fee) and information to construct an engagement measure (e.g., number of accesses, downloads, ad impressions or the like). The set of purchased units and values correspond to the points in the demand map.

The minimum, maximum and normal price lines are each constructed from a linear segment from the origin to (x₀, y₀) and a logarithmic section from (x₀, y₀) to (x₁, y₁) and beyond. (In an alternate embodiment, the logarithmic section can be approximated by one or more piecewise linear segments.) The normal price line is calculated as follows; the maximum price line is calculated similarly, but with different values for (x₀, y₀) and (x₁, y₁). (More precisely, both normal and maximum lines share x₀ and x₁, but have different y₀ and y₁.). The minimum price line can also be calculated like the normal and maximum price line (with the same x0 and x1 as for the other two lines and with values y0 and y1 unique to the minimum price line), or it can be derived directly from the normal line (e.g. the y-values of the minimum line can be chosen to be a percentage of the y-values of the normal line, for the same x-value. In that case, a percentage of 80% has been used successfully)

The normal price line f(x) is defined as:

$$\begin{matrix}f ( x ) = m \cdot x & 0 \leq x \leq {x}_{0} \\ = a \cdot ln ( x + b ) + c & x > {x}_{0}\end{matrix}$$

From a given set of (x₀, y₀), (x₁, y₁) values, the constants governing the minimum price line can be computed as follows:

$$m = \frac{{y}_{0}}{{x}_{0}}$$

$$a = {y}_{0} \frac{{x}_{0} + b}{{x}_{0}}$$

$$c = {y}_{0} ( 1 - \frac{{x}_{0} + b}{{x}_{0}} ln ( {x}_{0} + b ) )$$

b is difficult to calculate through a formula, but can be found by iteration (e.g., binary search). It satisfies the equation:

$$\frac{{y}_{1} - {y}_{0}}{{y}_{0}} = \frac{{x}_{0} ∓ b}{{x}_{0}} ln ( \frac{{x}_{1} + b}{{x}_{0} + b} )$$

The points (x₀, y₀) and (x₁, y₁) that describe the price lines may be determined as follows. This method does not assume an a priori value of the service to the user; rather, it assumes that the typical user is paying the right price. For x₀, choose the median engagement across all accounts. For y₀, choose the median revenue of all accounts with engagement near x₀ (in other words, half of the accounts with near median engagement have revenue ≧y₀, the other half have revenue ≦y₀)

For x₁, choose a value near the 90^{th} percentile of engagement. For y₁, choose a value lower than revenue for at least half of users or accounts near x₁. y₁ should not be smaller than necessary unless it appears to offer an unreasonably small volume discount. Empirically, a volume discount of about 60% seems to be well-accepted by customers.

The maximum price line is located similarly, but y₁ is set to about the 95^{th} percentile of accounts with engagement between x₀ and x₁. y₀ is computed from x₀, x₁, y₁ and a volume discount specific to maximum price lines. For the maximum price line a volume discount of 20% works well in separating accounts that are overpaying highly and are at risk of churning from those accounts that have high license fees but also high engagements and that are not at risk of churning.

Under some distributions of sales/user data, the price lines determined as described above may not be useful. Thus, an embodiment may allow the user to adjust the positions of (x₀, y₀) and (x₁, y₁) directly, or by changing the basic parameters that control the selection of those points, to obtain a reasonable separation of customers into “too high,” “too low” and “just right.” In addition, direct control of the minimum and maximum price lines can be used to produce an “after” study that is directly comparable to a first study and shows whether pricing model changes undertaken after the first study were effective to improve customer/price distribution.

In an interactive pricing-study tool, it is useful to offer both numeric and visual feedback to show the number of accounts in each of the three areas of the demand map with a given set of minimum and maximum price lines. The ability to zoom into an area of the map is also helpful. An estimate of revenue if all accounts outside the “just right” triangular area are moved into the area via price changes, and identification of accounts that will see the largest increases or decreases, is desirable.

It is appreciated that an embodiment of the invention can be used to identify and analyze pricing disparities affecting the sale of real-world services, as well as “digital” services. For example, records of customers' use of an exercise gym can be processed as described above, and a demand map plotting monthly membership cost vs. number of visits can be prepared. This will indicate which customers receive relatively low and relatively high value from their memberships, and consequently which customers may be good targets for special offers or other pricing-optimization tactics.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In some embodiments, the instructions for a programmable processor may be treated as data and used to modulate a carrier signal, which can subsequently be sent to a remote receiver, where the signal is demodulated to recover the instructions, and the instructions are executed to implement the methods of an embodiment at the remote receiver. In the vernacular, such modulation and transmission are known as “serving” the instructions, while receiving and demodulating are often called “downloading.” In other words, one embodiment “serves” (i.e., encodes and sends) the instructions of an embodiment to a client, often over a distributed data network like the Internet. The instructions thus transmitted can be saved on a hard disk or other data storage device at the receiver to create another embodiment of the invention, meeting the description of a machine-readable medium storing data and instructions to perform some of the operations discussed above. Compiling (if necessary) and executing such an embodiment at the receiver may result in the receiver performing operations according to a third embodiment.

In the preceding description, numerous details were set forth. It will be apparent, however, to one skilled in the art, that the present invention may be practiced without some of these specific details. In some instances, well-known structures and devices are shown in block diagram form, rather than in detail, in order to avoid obscuring the present invention.

Some portions of the detailed descriptions may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, including without limitation any type of disk including floppy disks, optical disks, compact disc read-only memory (“CD-ROM”), and magnetic-optical disks, read-only memories (ROMs), random access memories (RAMs), erasable, programmable read-only memories (“EPROMs”), electrically-eraseable read-only memories (“EEPROMs”), magnetic or optical cards, or any type of media suitable for storing computer instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will be recited in the claims below. In addition, the present invention is not described with reference to any particular programming language. It will be appreciated that a variety of programming languages may be used to implement the teachings of the invention as described herein.

The applications of the present invention have been described largely by reference to specific examples and in terms of particular allocations of functionality to certain hardware and/or software components. However, those of skill in the art will recognize that identification, qualification and quantification of pricing anomalies can also be produced by software and hardware that distribute the functions of embodiments of this invention differently than herein described. Such variations and implementations are understood to be captured according to the following claims.

We claim:

1. A method for adjusting pricing of a digital service comprising:
computing a revenue measure and an engagement measure for each customer of a plurality of customers;
separating the plurality of customers into three groups, wherein each member of a first group has a higher revenue/engagement quotient than members of a second group or a third group and each member of the third group has a lower revenue/engagement quotient than members of the first group or the second group; and
adjusting a price charged to a member of the first group or the third group to cause the member's revenue/engagement quotient to fall in the second group.

2. The method of claim 1 wherein the revenue measure and the engagement measure for each customer are computed over a common period of time.

3. The method of claim 2 wherein the engagement measure for a customer is proportional to a temporal duration of service access by the customer divided by a temporal duration of the common period of time.

4. The method of claim 1 wherein the engagement measure for a customer is proportional to a measure of an identifiable customer behavior.

5. The method of claim 1 wherein the engagement measure for a customer is proportional to a number of digital service accesses by the customer.

6. The method of claim 1 wherein the engagement measure for a customer is proportional to a quantity of data downloaded by the customer.

7. The method of claim 1, further comprising:
producing a scatter plot of the revenue and engagement measures for each customer of the plurality of customers; and
superimposing two curves on the scatter plot to separate an area of the scatter plot into three sub-areas, each sub-area corresponding to one of the first group, the second group or the third group of customers.

8. The method of claim 7 wherein the two curves are rays extending from an origin of the scatter plot and each of the three sub-areas are triangular in shape.

9. The method of claim 7 wherein at least one of the two curves is constructed of a linear segment and a logarithmic segment.

10. The method of claim 7 wherein at least one of the two curves is a curve approximated by a plurality of piecewise-linear segments.

11. The method of claim 7 wherein at least one of the two curves is constructed of a linear segment from an origin to a point at (x₀, y₀), x₀ chosen as a median value of engagement across the plurality of customers and y₀ chosen as a median revenue across the plurality of customers having an engagement measure near x₀; and
a logarithmic section from (x₀, y₀) through (x₁, y₁), x₁ chosen near a 90^{th} percentile value of engagement across the plurality of customers and y₁ chosen as less than the revenue measure of at least half of the plurality of customers having an engagement measure near x₁.

12. The method of claim 7 wherein a second of the two curves is set at approximately 80% of a value of a first of the two curves.

13. A system comprising:
a computer for delivering a digital service to a plurality of subscribers via a distributed data network;
a database for recording information about the subscribers' use of the digital service;
computer logic to prepare a demand map showing information about services delivered to the plurality of subscribers over a period of time and fees paid by the plurality of subscribers over the period of time; and
a user interface to display the demand map and accept parameters to control the computer logic.

14. The system of claim 13 wherein the user interface further displays an estimate of an increased revenue opportunity.

15. The system of claim 13 wherein the user interface further displays an estimated range of an increased revenue opportunity.

16. The system of claim 13 wherein the user interface further displays a normal price line on the demand map.

17. The system of claim 13, further comprising:
a historical record containing information to allow preparation of a second demand map representing the plurality of subscribers over a different period of time, wherein
the user interface is to display the demand map and the second demand map to permit comparison of the two demand maps.

18. A computer-readable medium containing executable instructions to cause a programmable digital processor to perform operations comprising:
retrieving revenue and service-consumption information about a plurality of customers from a database;
separating the plurality of customers into sub-groups of customers who have similar measures of revenue and service-consumption; and
listing the customers in one of the sub-groups.

19. The computer-readable medium of claim 18, containing additional executable instructions to cause the programmable digital processor to perform operations comprising:
generating a graphical display showing the sub groups of the plurality of customers.

20. The computer-readable medium of claim 18, containing additional executable instructions to cause the programmable digital processor to perform operations comprising:
emitting a machine-processable document to schedule a sales activity targeting a customer of one of the sub-groups.

21. A method for analyzing a digital-service-providing business comprising:
computing a revenue measure and an engagement measure for each customer of a plurality of customers who consume a digital service;
sorting the plurality of customers into a plurality of groups, wherein members of each group have similar revenue/engagement quotients; and
altering a condition under which customers in one group receive the digital service to change the revenue/engagement quotient of the customers so that the customers will be sorted into a different group.

22. The method of claim 21 wherein the condition is a price paid by the customers to receive the digital service.
